(19) United States
(12) Patent Application Publication
(10) Pub. No.: US 2019/0184910 A1
(43) Pub. Date: Jun. 20, 2019

(54) LIVE STREAMING SECURITY SYSTEM

(71) Applicant: Sean Lamar Bazille, Los Angeles, CA (US)

(72) Inventor: Sean Lamar Bazille, Los Angeles, CA (US)

(21) Appl. No.: 16/220,466

(22) Filed: Dec. 14, 2018

Related U.S. Application Data
(60) Provisional application No. 62/598,675, filed on Dec. 14, 2017.

(51) Int. Cl. B60R 11/04; B60R 1/00

(52) U.S. Cl. CPC B60R 11/04; B60R 1/00; B60R 2300/8006; B60R 2300/105; B60R 2300/303; B60R 2300/8073

(57) ABSTRACT

A live streaming security/safety system for an automobile having a plurality of audio and video cameras installed in and around the automobile. A control processor device operatively connected to each of the plurality of cameras by wired or wireless connection. A memory storage device is included for storing audio and video data received by the cameras, as well as, a wireless transmitter for broadcasting such audio and video data. The security/safety system can be activated to record and selectively live stream audio and video in and around the automobile. A third-party observer may also wirelessly connect to the system through the wireless transmitter for viewing the audio and video data, as well as, communicating with people in and around the automobile.

### RELATED APPLICATIONS

This application claims the benefit of U.S. Provisional Application No. 62/598,675, filed on Dec. 14, 2017.

### BACKGROUND OF THE INVENTION

The present invention is directed to a safety and security system. More particularly, the present invention is directed to a system of audio/video recording devices coupled with a live-streaming/social media service to document and monitor people and property during public encounters.

The proliferation of audio and video recording devices has led to an increased number of public encounters that are recorded for security and/or protection reasons. However, such audio and video recording devices are usually fixed and/or not actively monitored until after an event of interest occurs. Because of the fixed or unmonitored status of these devices, the recordings of the encounters may be off-frame, out of focus, garbled, or otherwise unclear. In addition, if the event of interest is mobile, then it will likely move away from the recording devices.

Such events of interest often happen in motor vehicles, e.g., police stops, road rage incidents, accidents, etc. Motor vehicles are often moving beyond recording devices or are on roadways without recording devices, e.g., highways, freeways, etc. While some buildings adjacent to roadways may have cameras, such are often pointed at the building or would otherwise have only limited views of the roadway. Such recordings are also not generally known to exist or are otherwise unavailable to the public without investigation or police assistance.

Accordingly, there is a need for an audio and video recording system that provides recording services for in and around a motor vehicle while making the recording readily available to the owner and public. The present invention fulfills these needs and provides other related advantages.

### SUMMARY OF THE INVENTION

The present invention is directed to a live streaming security/safety system for an automobile. The system has a plurality of cameras installed in and around the automobile, a control processor device installed in the automobile and operatively connected to each of the plurality of cameras, a memory storage device operatively connected to the control processor device and configured for storing audio and video data received or recorded by the plurality of cameras, and a wireless transmitter included in the control processor configured for communication with a remote monitoring service.

The plurality of cameras include at least a driver facing camera, a rear facing camera, and a forward facing camera. The plurality of cameras further include a passenger compartment camera, a passenger facing camera, or a side view camera. The forward facing camera preferably has multiple cameras, including a center camera, a driver-side angle camera, and a passenger-side angle camera.

The system may further include an activation button in a passenger compartment of the automobile operatively connected to the control processor device, as well as a speaker operatively connected to the control processor device. The system may also include a software application installed on a computing device, wherein the computing device is wirelessly and operatively connected to the control processor device.

The system may also include inertia sensors operatively connected to the control processor device and configured to activate the system in the case of sudden changes in speed or orientation of the automobile. The inertia sensors may include impact sensors for bumpers on the automobile.

A process for live streaming audio and video around an automobile includes providing a live streaming security/safety system in an automobile, the security/safety system comprising a plurality of cameras, a control processor device, a memory storage device, and a wireless transmitter operatively connected together. The plurality of cameras records audio and video data from around the automobile. The wireless transmitter then transmits the recorded audio and video data. The transmitted audio and video is then live streamed over the Internet.

The audio and video data may be stored in the memory storage device. The audio and video data may be communicated to a third-party observer at a location distal from the automobile. The live streaming security/safety system may also have a speaker operatively connected to the control processor device, where the third-party observer can wirelessly transmit audio data through the speaker.

The plurality of cameras may include a driver-facing camera, a rear-facing camera, and a front-facing camera. The front-facing camera may include a driver-side angle camera and a passenger-side angle camera. The live streaming security/safety system may further include a software application configured for installation on a mobile computing device. The software application is preferably configured to remotely activate the live streaming security/safety system when installed on a mobile computing device.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an schematic, perspective view of an automobile incorporating the inventive live streaming security system of the present invention; and

FIG. 2 is a schematic, top view of an automobile incorporating the inventive live streaming security system of the present invention.

### DETAILED DESCRIPTION OF THE PREFERRED EMBODIMENTS

The system of the present invention relates to a live streaming safety/security system for users involved in public events in and around their automobile. The goal of the system is to provide additional safety and security to a user in their automobile when involved in potentially hazardous of dangerous situations, e.g., automobile accidents, road rage incidents, mechanical failures of automobile, police stops, etc.

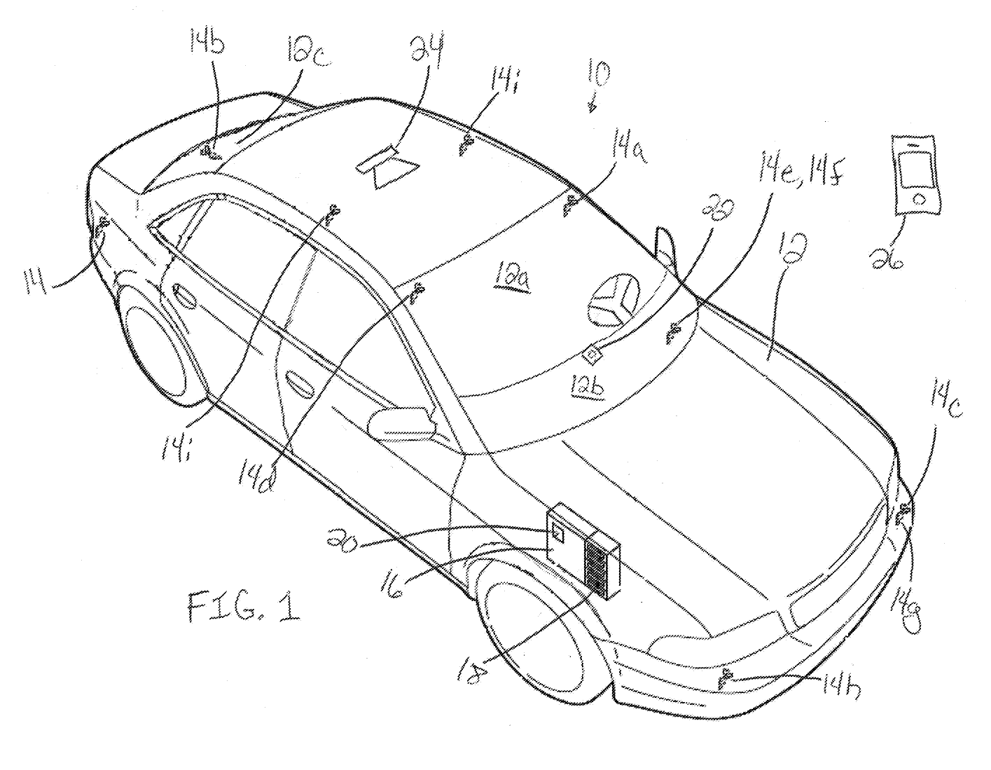

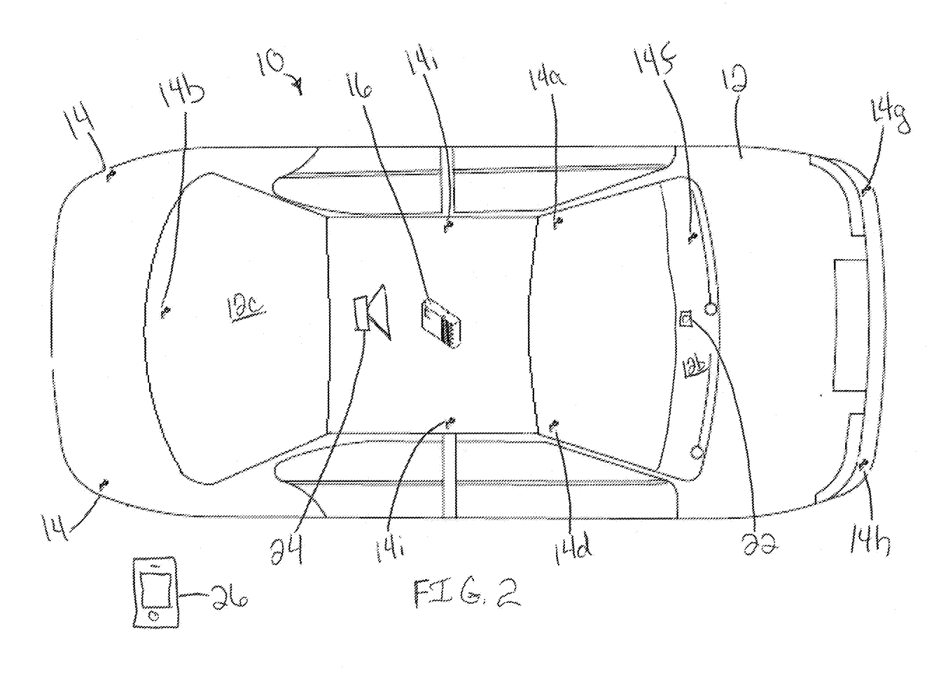

The inventive live streaming safety/security system, generally referred to numeral 10 in FIGS. 1 and 2, is preferably installed in an automobile 12. The system 10 may be installed during initial manufacture (OEM) or as an after-market device. The system 10 consists of a plurality of video/audio cameras 14 disposed in strategic locations around the automobile 12, along with a control processor device 16. The control processor 16 may be installed anywhere on the vehicle 12 that is practical or convenient, including in the engine compartment, the passenger compartment, the trunk, or anywhere else. The control processor 16 is connected to each of the cameras 14 either through wired connections or wireless, i.e., Bluetooth®, Wi-Fi, or similar wireless protocols.

The control processor 16 includes memory storage 18 configured to store images and audio recorded from the plurality of cameras 14. Such memory storage 18 can be for long term storage or a short-term buffer. Regardless of the duration of storage in the memory, the audio and video captured by the cameras 14 is preferably live streamed to a social media outlet or other outlet as described below. The control processor 16 also includes transmitter 20 configured to permit connection between the system 10 and the internet. The transmitter 20 may be a cellular transmitter or similar apparatus used to connect the similar computer based systems in automobiles 12 to various internet services, i.e., streaming, social media, GPS tracking, etc.

As described, the safety system 10 preferably includes a plurality of recording devices 14, a control processor 16, memory storage 18, and a wireless transmitter 20. In addition to providing an outlet for connection to the Internet or social media for live streaming, the wireless transmitter 20 may also provide a wireless connection to a remote third-party, such as On-Star® or similar service.

The memory storage 18 is preferably digital memory storage to maintain a copy of recorded audio and video, onboard the automobile. In addition, the wireless transmitter 20 may permit the control processor 16 to transfer any recorded audio or video to a remote memory device or the cloud, simultaneous with streaming. The memory storage 18 may also provide a method of preserving the recorded audio or video if the wireless transmitter 20 is unable to connect to a network, i.e., weak or no signal for cellular transmission. A driver of the automobile 12 preferably has access to a control mechanism 22, such as a switch or a button, to turn on the safety system 10.

In a particularly preferred embodiment, the safety system 10 comprises a plurality of audio and video cameras 14 distributed around the automobile 12. Ideally, the system 10 includes at least a driver's face camera 14a, a rear-facing camera 14b, and a forward-facing camera 14c. The cameras 14 may be wide angle so as to capture as much of the activity in the oriented field of view. For example, the driver's face camera 14a may be configured so as to capture the entire passenger compartment 12a of the automobile 12. Alternatively, the system 10 may include a driver face camera 14a and a second interior camera, for example, a passenger face camera 14d, or a passenger compartment camera 14e in the center of the windshield or dashboard 12b for capturing the remainder of the interior 12a.

The rear-facing camera 14b may be positioned in the rear window 12c or on the trunk lid. The system 10 may be configured to integrate existing back-up cameras that exist on certain models of vehicles 12. The problem with such cameras is that they tend of have a narrow focus of the ground or as wide as the bumper on the automobile. Therefore, it is more desirable to provide a rear-facing camera 14b that is positioned at a higher angle with a wider viewing range.

The forward-facing camera 14c preferably has a wide angle lens to capture as wide a view to the front of the automobile 12. More preferably, the forward-facing camera 14c utilizes multiple cameras, including a center camera 14f, a driver-side angle camera 14g, and a passenger-side angle camera 14h. This configuration allows for the capture of a much wider viewing angle of the front of the automobile 12. The system 10 may also include additional cameras, such as side view cameras 14i pointed at the sides of the automobile 12 so as to capture lateral views.

As mentioned above, the cameras 14 preferably include integrated audio and video recording capabilities, particularly the cameras recording the passenger compartment 12a or the side view cameras 14i. The system 10 is preferably configured and/or positioned so as to record audio from both the interior and the exterior of the automobile 12. The system 12 may also include a speaker 24 configured to broadcast audio that can be heard in both the interior and exterior of the automobile. The speaker 24 is configured to allow the user of the system 10 to hear responses from a remote third-party as described below.

As mentioned above, the system 10 includes a wireless communications link 20, such as cellular or Wi-Fi connectivity. The wireless communications link 20 is designed, in part, to provide connectivity between the system 10 and a third-party service, such as On-Star® or similar service. The third-party service is designed to activate and monitor the audio and video devices 14 in the system 10, as well as, connect the audio and video feeds from the system to live streaming or similar internet broadcasting services as might be found on social media services. When the audio and video feeds from the system 10 are live streamed, people that are connected to the owner of the automobile 12 as by social media or similar services can view the live feed. The audio and video streams are preferably also recorded for later viewing.

In addition to linking the social media and live streaming to the owner of the automobile, as through the on-board processor 16 or similar computing device in the automobile 12, the social media and live streaming may be linked to an app or similar program on a tablet or smartphone device 26 owned by a passenger or driver other than the owner of the automobile 12. This is so that a person that borrows an automobile 12 from another or has a rental automobile equipped with the inventive system 10 may still benefit from the functionality.

The tablet or smartphone device 26 may connect to the on-board computing device 16 in the automobile 12 as such devices are known to link, e.g., hardwire, Bluetooth® or similar. Through this link, an app on the tablet or smartphone 26 is able to access the audio and video devices 14, and connect to the third-party provider through the wireless connection 20 in the automobile 20 or the tablet/smartphone 26.

In use, when a person driving an automobile 12 equipped with the inventive system 10 becomes aware of a potentially dangerous, hazardous, or otherwise noteworthy situation, the driver may activate the system 10. Such potentially dangerous, hazardous, or otherwise noteworthy situations might include a police traffic stop, an incident of road rage, an auto accident, or other incident on a roadway or in a parking lot. The system 10 is designed to make an audio and video record of the entire incident from the moment the audio and video devices are turned on. A person in the employ of the third-party service may act as a witness to the events being recorded and may communicate with any persons around the automobile 12 at the time of the incident.

In a preferable embodiment of the system 10, activating the system put the driver and passengers of the automobile 12 in audio contact with the third-party service. The third-party service confirms the proper initiation of the audio and video devices 14 and announces over the speaker 24 that the service is activated and that audio and video are being recorded. Such announcement serves to put the surrounding public on notice that a recording is taking place and that their actions or words may be recorded. In certain types of incidents, such announcement may also serve to cause people to behave differently knowing that their actions are being recorded. The ideal goal of this system is to keep the driver and passengers of the automobile safer during an incident that causes activation.

As part of the activation of the system 10, the third-party service also links the audio and video streams to a live streaming service or other social media platform. Such linking of the audio and video streams ensures that the driver's friends or a larger segment of the public is aware of and following the events of the incident. The primary goal of such live streaming is to ensure greater public awareness of potentially dangerous or hazardous events, and to increase protection and accountability.

Once the incident is completed, e.g., the police officer allows the vehicle to depart or a road rage incident is passed, the third-party service can terminate the operation of the system 10 once confirming with the driver or passengers that the incident is completed.

In addition to the manual activation of the system 10, the system 10 may include inertia sensors, i.e., accelerometers or similar devices, to detect sudden changes in speed or vehicle orientation, as may occur in a traffic accident. If such sudden changes do occur, the system may be programmed to alert the third-party service. Upon such alert, the third-party service may announce themselves over the speakers 24, inquire as to whether there has been an accident or other incident, and activate the audio and video devices 14 if necessary.

The system 10 may also include an on-board memory buffer 18 to hold a pre-determined amount of audio and video recordings, e.g., five to ten minutes or longer, so that events preceding the activation of the system 10 are available for the record if the driver or passenger does not activate the system 10 right away or is delayed in activating for some reason.

Utilization of the inventive system 10 can be used to protect police officers, citizens, make traffic stops safer and more visible, he resolve Amber Alerts, and minimize threats in road rage incidents. The accountability inherent in the system 10 is designed to change the way drivers, passengers, and other occupants interact with law enforcement in and around a vehicle. The system 10, with cameras 14 positioned around the interior and exterior of the automobile 12, is designed to live stream and record interactions between drivers and passengers in vehicles with policer officers and other around the vehicle. A third-party technician can remotely monitor and interact with people around the vehicle. Ideally, the automobile 12 may be equipped with a label, sticker, or similar sign to alert people around the vehicle that they are being recorded.

In the instance of a traffic stop, once a driver is aware that a police officer has signaled for him/her to pull the vehicle over, the driver can activate the system 10, as by pressing the button 24. Upon pressing the button 24, a third-party technician can connect to the system 10 in real-time to begin monitoring. The cameras 14 being recording audio and video both for storage and streaming. The third-party technician can verbally notify both the driver and persons around the vehicle that they are monitoring the interaction. Such monitoring by a remote third-party is intended to prevent escalation of the incident in a negative direction.

In addition to the physical system 10 installed in the automobile 12, a remote database can be maintained that tracks interactions with particular law enforcement officers or departments. The database can track interactions by departments overall, by individual officers, or both. Rating and reviews can be assigned to each department or officer, along with a digital record of the audio and video from the interaction.

The system 10 can also be used by parents and driving instructors to monitor new or student drivers for safety and security. Remote activation of the system 10 can be performed if there is concern over safety or security. Remote activation can also be used in the case of a vehicle being stolen or lost to recover the vehicle promptly as through GPS tracking. The audio and video recording can be useful to identify and prosecute car thieves.

Although several embodiments have been described in detail for purposes of illustration, various modifications may be made without departing from the scope and spirit of the invention. Accordingly, the invention is not to be limited, except as by the appended claims.

What is claimed is:

1. A live streaming security/safety system for an automobile, comprising:
a plurality of cameras installed on the automobile;
a control processor device installed in the automobile and operatively connected to each of the plurality of cameras;
a memory storage device operatively connected to the control processor device and configured for storing data recorded by the plurality of cameras; and
a wireless transmitter included in the control processor configured for communication with a remote monitoring service.

2. The live streaming security/safety system for an automobile of claim 1, wherein the plurality of cameras comprise at least a driver facing camera, a rear facing camera, and a forward facing camera.

3. The live streaming security/safety system for an automobile of claim 2, wherein the plurality of cameras further comprise a passenger compartment camera, a passenger facing camera, or a side view camera.

4. The live streaming security/safety system for an automobile of claim 2, wherein the forward facing camera comprises multiple cameras, including a center camera, a driver-side angle camera, and a passenger-side angle camera.

5. The live streaming security/safety system for an automobile of claim 1, further comprising an activation button in a passenger compartment of the automobile operatively connected to the control processor device.

6. The live streaming security/safety system for an automobile of claim 1, further comprising a speaker operatively connected to the control processor device.

7. The live streaming security/safety system for an automobile of claim 1, further comprising a software application installed on a computing device, wherein the computing device is wirelessly and operatively connected to the control processor device.

8. The live streaming security/safety system for an automobile of claim 1, further comprising inertia sensors operatively connected to the control processor device and configured to activate the system in the case of sudden changes in speed or orientation of the automobile.

9. The live streaming security/safety system for an automobile of claim 8, wherein the inertia sensors include impact sensors for bumpers on the automobile.

1. A process for live streaming audio and video around an automobile, comprising the steps of:
providing a live streaming security/safety system in an automobile, the security/safety system comprising a plurality of cameras, a control processor device, a memory storage device, and a wireless transmitter operatively connected together;
recording audio and video data from around the automobile using the plurality of cameras;
transmitting the audio and video data through the wireless transmitter; and
live streaming the transmitted audio and video data over the Internet.

11. The process of claim 10, further comprising the step of storing the audio and video data in the memory storage device.

12. The process or claim 10, further comprising the step of communicating the audio and video data to a third-party observer at a location distal from the automobile.

13. The process or claim 12, wherein the live streaming security/safety system further comprises a speaker operatively connected to the control processor device; and wherein the third-party observer can wirelessly transmit audio data through the speaker.

14. The process or claim 10, wherein the plurality of cameras comprises a driver-facing camera, a rear-facing camera, and a front-facing camera.

15. The process or claim 14, wherein the front-facing camera comprises a driver-side angle camera and a passenger-side angle camera.

16. The process or claim 10, wherein the live streaming security/safety system further comprises a software application configured for installation on a mobile computing device.

17. The process or claim 16, wherein the software application is configured to remotely activate the live streaming security/safety system when installed on a mobile computing device.
